(19) United States
(12) Patent Application Publication
(10) Pub. No.: US 2024/0003581 A1
(43) Pub. Date: Jan. 4, 2024

(54) SYSTEM AND METHOD FOR AVOIDING STALL REGIONS USING MULTIPLE HVAC FANS

(71) Applicant: Johnson Controls Tyco IP Holdings LLP, Milwaukee, WI (US)

(72) Inventors: Ritesh Babulal Agrawal, Dombivli (IN); Vishal Shivaji Jagtap, Pune (IN); Nivedita Nath, Pune (IN); Aron Marc Seiler, Sparks, MD (US); Curtis Wayne Caskey, Hanover, PA (US)

(21) Appl. No.: 18/215,671

(22) Filed: Jun. 28, 2023

Related U.S. Application Data
(60) Provisional application No. 63/356,589, filed on Jun. 29, 2022.

(51) Int. Cl. F24F 11/77

(52) U.S. Cl. CPC F24F 11/77

(57) ABSTRACT

A heating, ventilation, and/or air conditioning (HVAC) system includes a variable-speed fan comprising a first fan blade, a variable frequency drive (VFD) configured to drive the variable-speed fan to rotate the first fan blade at various speeds to deliver a first airflow at variable airflow rates, and a constant-speed fan having a second fan blade. The HVAC system also includes a fan motor of the constant-speed fan configured to rotate the second fan blade at a fixed speed to deliver a second airflow, and a controller configured to determine an operational combination of the variable-speed fan and the constant-speed fan that achieves a target flow rate with a combination of the first airflow and the second airflow without operating the variable-speed fan in a stall region based on stall region data for the variable-speed fan.

### CROSS REFERENCE TO RELATED APPLICATIONS

This application claims priority from and the benefit of Provisional Application No. 63/356,589, entitled “SYSTEM AND METHOD FOR AVOIDING STALL REGIONS USING MULTIPLE HVAC FANS,” filed Jun. 29, 2022, which is hereby incorporated by reference in its entirety for all purposes.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Heating, ventilation, and/or air conditioning (HVAC) systems (e.g., exhaust fan systems) often employ fans to move air of certain pressures at certain airflow rates. It is now recognized that traditional fans used in such systems are unable to operate at pressures and airflow rates outside of certain ranges, restricting the conditions within which each fan can operate and limiting desired system operations.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a heating, ventilation, and/or air conditioning (HVAC) system includes a variable-speed fan comprising a first fan blade, a variable frequency drive (VFD) configured to drive the variable-speed fan to rotate the first fan blade at various speeds to deliver a first airflow at variable airflow rates, and a constant-speed fan having a second fan blade. The HVAC system also includes a fan motor of the constant-speed fan configured to rotate the second fan blade at a fixed speed to deliver a second airflow, and a controller including memory and one or more processors. The one or more processors is configured operate based on instructions in the memory such that the controller is configured to determine an operational combination of the variable-speed fan and the constant-speed fan that achieves a target flow rate with a combination of the first airflow and the second airflow without operating the variable-speed fan in a stall region based on stall region data for the variable-speed fan.

In another embodiment, an exhaust system for a heating, ventilation, and/or air conditioning (HVAC) system includes a variable-speed exhaust fan configured to deliver a first airflow from a conditioned space at a variable airflow rate, a variable frequency drive (VFD) configured to drive the variable-speed exhaust fan at various speeds, and a constant-speed exhaust fan configured to deliver a second airflow from the conditioned space. The exhaust system also includes a fan motor configured to drive the constant-speed exhaust fan at a constant speed, and a controller configured to receive a target airflow rate, receive stall region data comprising an array of operational parameters of the variable-speed exhaust fan that result in decreased performance, and determine, based on the target airflow rate and stall region data, an operational combination of the variable-speed fan and the constant-speed fan that achieves the target flow rate with a combination of the first airflow and the second airflow without operating the variable-speed fan in a stall region.

In another embodiment, a method includes receiving, via a controller, a target airflow rate for an exhaust system. The target airflow rate includes an airflow rate value to be delivered by the exhaust system, which includes at least a variable-speed fan and a constant-speed fan. The method also includes receiving, via the controller, stall region data comprising an array of airflow rates within stall regions of that variable-speed fan that result in decreased performance for the variable-speed fan, determining, via the controller and based on the stall region data, that the variable-speed fan is set for operating at an airflow rate that is in one of the stall regions, and in response to determining that variable-speed fan is set for operating in the one of the stall regions, activating, via the controller, the constant-speed fan and operating the variable-speed fan at an airflow rate outside of the stall regions such that combined airflow from the variable-speed fan and the constant-speed fan correspond to the target airflow rate.

### BRIEF DESCRIPTION OF THE DRAWINGS

Various aspects of this disclosure may be better understood upon reading the following detailed description and upon reference to the drawings in which:

FIG. 1 is a perspective view of an embodiment of a building with a heating, ventilation, and/or air conditioning (HVAC) system in a commercial setting, in accordance with an aspect of the present disclosure;

FIG. 2 is a perspective view of an embodiment of a packaged HVAC unit, in accordance with an aspect of the present disclosure;

FIG. 3 is a perspective view of an embodiment of a split, residential HVAC system, in accordance with an aspect of the present disclosure;

FIG. 4 is a schematic diagram of an embodiment of a vapor compression system that may be used in an HVAC system, in accordance with an aspect of the present disclosure;

FIG. 5 is a schematic diagram of an embodiment of an HVAC system for controlling a plurality of fan units, in accordance with an aspect of the present disclosure;

FIG. 6 is a table of a plurality of stall regions for a fan unit of the plurality of fan units of FIG. 5 at different static pressures and airflow rates, in accordance with an aspect of the present disclosure;

FIG. 7 is a chart depicting a stall region for a fan unit of the plurality of fan units of FIG. 5 at different static pressures and airflow rates, in accordance with an aspect of the present disclosure;

FIG. 8 is a block diagram illustrating a method for operating the HVAC system of FIG. 5 at different pressures and airflow rates, in accordance with an aspect of the present disclosure;

FIG. 9 is a schematic diagram of an embodiment of an HVAC system for controlling a plurality of fan units, in accordance with an aspect of the present disclosure; and

FIG. 10 is a block diagram illustrating a method for operating the HVAC system of FIG. 9, in accordance with an aspect of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure relates generally to a system for operating a plurality of fans of a heating, ventilation, and/or air conditioning system to avoid stall regions for each fan.

In many heating, ventilation, and/or air conditioning (HVAC) systems, it is common to employ fans to achieve a desired airflow rate. Utilizing multiple fans as opposed to a single large, more expensive fan may reduce a size of the system and decrease manufacturing and operation costs. For example, instead of utilizing a single fan to deliver an airflow rate of 5000 cubic feet per minute (CFM), a user may utilize two smaller fans to each deliver 2500 CFM to achieve the desired 5000 CFM total. However, in certain conditions, fans may encounter stall regions. Stall regions are ranges of operating conditions in which fans operate at a reduced performance state. For example, fans operating in stall regions may produce increased noise, experience unstable operation, fail prematurely, or operate at a reduced level of efficiency. A stall region may include a range of static pressures and airflow rates. For example, a fan may move air at a static pressure of 2.0 inches of water (in-wg) at an airflow rate of 3000 CFM. In some cases, this combination of static pressure and airflow rate may be within a stall region for the fan. In this situation, the fan may operate at a reduced efficiency (e.g., the fan may utilize an increased amount of electrical power to operate but without a corresponding increase is airflow rate) or may cease to operate at all. Additionally, independently controlling multiple fans may require more costly equipment than operating a single fan. Thus, it is presently recognized that it is desirable to have a system for moving air in an HVAC system that is cost effective and avoids stall regions for a plurality of fans.

Accordingly, present embodiments are directed to a system for controlling a plurality of fans to operate without entering stall regions. For example, a controller of the system may operate a constant-speed fan and a variable-speed fan to deliver a desired airflow rate at a certain pressure without entering a stall region of the constant-speed fan or a stall region of the variable-speed fan. The system is described in greater detail below.

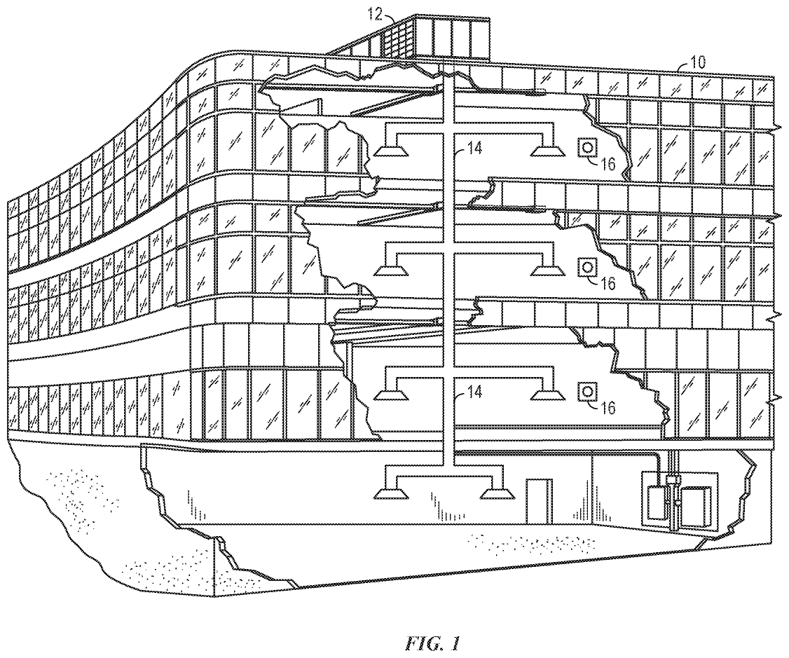

Turning now to the drawings, FIG. 1 illustrates an embodiment of a heating, ventilation, and/or air conditioning (HVAC) system for environmental management that employs one or more HVAC units. As used herein, an HVAC system includes any number of components configured to enable regulation of parameters related to climate characteristics, such as temperature, humidity, air flow, pressure, air quality, and so forth. For example, an “HVAC system” as used herein is defined as conventionally understood and as further described herein. Components or parts of an “HVAC system” may include, but are not limited to, all, some of, or individual parts such as a heat exchanger, a heater, an air flow control device, such as a fan, a sensor configured to detect a climate characteristic or operating parameter, a filter, a control device configured to regulate operation of an HVAC system component, a component configured to enable regulation of climate characteristics, or a combination thereof. An “HVAC system” is a system configured to provide such functions as heating, cooling, ventilation, dehumidification, pressurization, refrigeration, filtration, or any combination thereof. The embodiments described herein may be utilized in a variety of applications to control climate characteristics, such as residential, commercial, industrial, transportation, or other applications where climate control is desired.

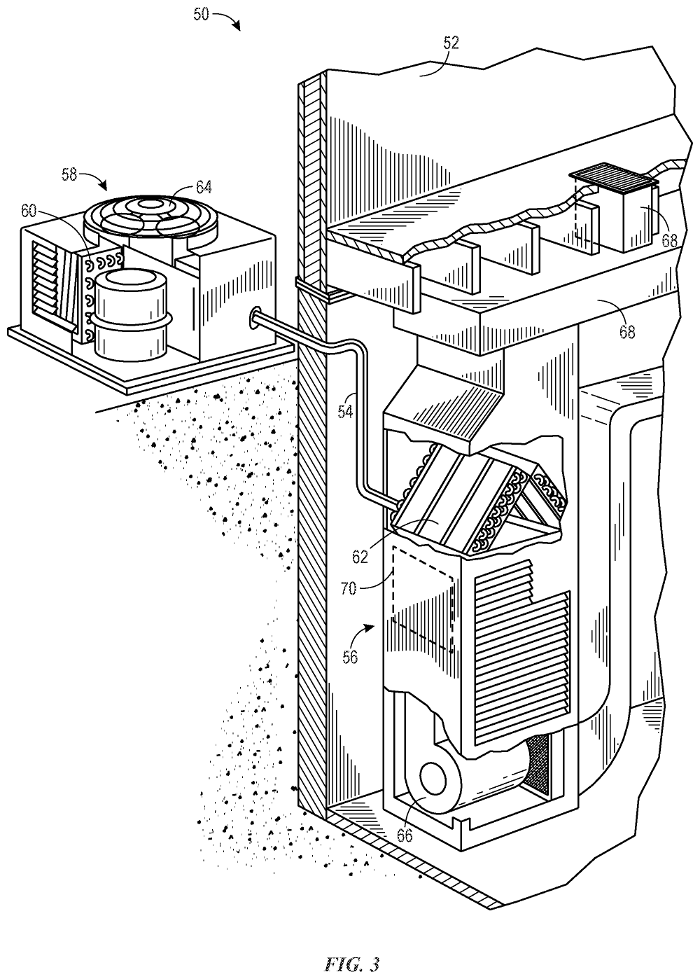

In the illustrated embodiment, a building 10 is air conditioned by a system that includes an HVAC unit 12. The building 10 may be a commercial structure or a residential structure. As shown, the HVAC unit 12 is disposed on the roof of the building 10; however, the HVAC unit 12 may be located in other equipment rooms or areas adjacent the building 10. The HVAC unit 12 may be a single package unit containing other equipment, such as a blower, integrated air handler, and/or auxiliary heating unit. In other embodiments, the HVAC unit 12 may be part of a split HVAC system, such as the system shown in FIG. 3, which includes an outdoor HVAC unit 58 and an indoor HVAC unit 56.

The HVAC unit 12 is an air-cooled device that implements a refrigeration cycle to provide conditioned air to the building 10. Specifically, the HVAC unit 12 may include one or more heat exchangers across which an air flow is passed to condition the air flow before the air flow is supplied to the building. In the illustrated embodiment, the HVAC unit 12 is a rooftop unit (RTU) that conditions a supply air stream, such as environmental air and/or a return air flow from the building 10. After the HVAC unit 12 conditions the air, the air is supplied to the building 10 via ductwork 14 extending throughout the building 10 from the HVAC unit 12. For example, the ductwork 14 may extend to various individual floors or other sections of the building 10. In certain embodiments, the HVAC unit 12 may be a heat pump that provides both heating and cooling to the building with one refrigeration circuit configured to operate in different modes. In other embodiments, the HVAC unit 12 may include one or more refrigeration circuits for cooling an air stream and a furnace for heating the air stream.

A control device 16, one type of which may be a thermostat, may be used to designate the temperature of the conditioned air. The control device 16 also may be used to control the flow of air through the ductwork 14. For example, the control device 16 may be used to regulate operation of one or more components of the HVAC unit 12 or other components, such as dampers and fans, within the building 10 that may control flow of air through and/or from the ductwork 14. In some embodiments, other devices may be included in the system, such as pressure and/or temperature transducers or switches that sense the temperatures and pressures of the supply air, return air, and so forth. Moreover, the control device 16 may include computer systems that are integrated with or separate from other building control or monitoring systems, and even systems that are remote from the building 10.

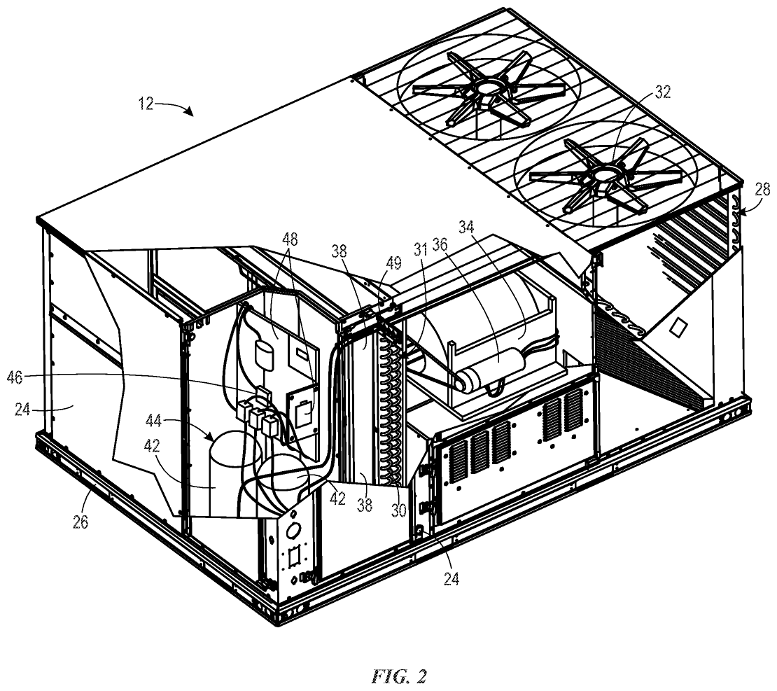

FIG. 2 is a perspective view of an embodiment of the HVAC unit 12. In the illustrated embodiment, the HVAC unit 12 is a single package unit that may include one or more independent refrigeration circuits and components that are tested, charged, wired, piped, and ready for installation. The HVAC unit 12 may provide a variety of heating and/or cooling functions, such as cooling only, heating only, cooling with electric heat, cooling with dehumidification, cooling with gas heat, or cooling with a heat pump. As described above, the HVAC unit 12 may directly cool and/or heat an air stream provided to the building 10 to condition a space in the building 10.

As shown in the illustrated embodiment of FIG. 2, a cabinet 24 encloses the HVAC unit 12 and provides structural support and protection to the internal components from environmental and other contaminants. In some embodiments, the cabinet 24 may be constructed of galvanized steel and insulated with aluminum foil faced insulation. Rails 26 may be joined to the bottom perimeter of the cabinet 24 and provide a foundation for the HVAC unit 12. In certain embodiments, the rails 26 may provide access for a forklift and/or overhead rigging to facilitate installation and/or removal of the HVAC unit 12. In some embodiments, the rails 26 may fit into “curbs” on the roof to enable the HVAC unit 12 to provide air to the ductwork 14 from the bottom of the HVAC unit 12 while blocking elements such as rain from leaking into the building 10.

The HVAC unit 12 includes heat exchangers 28 and 30 in fluid communication with one or more refrigeration circuits. Tubes within the heat exchangers 28 and 30 may circulate refrigerant, such as R-410A, through the heat exchangers 28 and 30. The tubes may be of various types, such as multichannel tubes, conventional copper or aluminum tubing, and so forth. Together, the heat exchangers 28 and 30 may implement a thermal cycle in which the refrigerant undergoes phase changes and/or temperature changes as it flows through the heat exchangers 28 and 30 to produce heated and/or cooled air. For example, the heat exchanger 28 may function as a condenser where heat is released from the refrigerant to ambient air, and the heat exchanger 30 may function as an evaporator where the refrigerant absorbs heat to cool an air stream. In other embodiments, the HVAC unit 12 may operate in a heat pump mode where the roles of the heat exchangers 28 and 30 may be reversed. That is, the heat exchanger 28 may function as an evaporator and the heat exchanger 30 may function as a condenser. In further embodiments, the HVAC unit 12 may include a furnace for heating the air stream that is supplied to the building 10. While the illustrated embodiment of FIG. 2 shows the HVAC unit 12 having two of the heat exchangers 28 and 30, in other embodiments, the HVAC unit 12 may include one heat exchanger or more than two heat exchangers.

The heat exchanger 30 is located within a compartment 31 that separates the heat exchanger 30 from the heat exchanger 28. Fans 32 draw air from the environment through the heat exchanger 28. Air may be heated and/or cooled as the air flows through the heat exchanger 28 before being released back to the environment surrounding the HVAC unit 12. A blower assembly 34, powered by a motor 36, draws air through the heat exchanger 30 to heat or cool the air. The heated or cooled air may be directed to the building 10 by the ductwork 14, which may be connected to the HVAC unit 12. Before flowing through the heat exchanger 30, the conditioned air flows through one or more filters 38 that may remove particulates and contaminants from the air. In certain embodiments, the filters 38 may be disposed on the air intake side of the heat exchanger 30 to prevent contaminants from contacting the heat exchanger 30.

The HVAC unit 12 also may include other equipment for implementing the thermal cycle. Compressors 42 increase the pressure and temperature of the refrigerant before the refrigerant enters the heat exchanger 28. The compressors 42 may be any suitable type of compressors, such as scroll compressors, rotary compressors, screw compressors, or reciprocating compressors. In some embodiments, the compressors 42 may include a pair of hermetic direct drive compressors arranged in a dual stage configuration 44. However, in other embodiments, any number of the compressors 42 may be provided to achieve various stages of heating and/or cooling. As may be appreciated, additional equipment and devices may be included in the HVAC unit 12, such as a solid-core filter drier, a drain pan, a disconnect switch, an economizer, pressure switches, phase monitors, and humidity sensors, among other things.

The HVAC unit 12 may receive power through a terminal block 46. For example, a high voltage power source may be connected to the terminal block 46 to power the equipment. The operation of the HVAC unit 12 may be governed or regulated by a control board 48. The control board 48 may include control circuitry connected to a thermostat, sensors, and alarms. One or more of these components may be referred to herein separately or collectively as the control device 16. The control circuitry may be configured to control operation of the equipment, provide alarms, and monitor safety switches. Wiring 49 may connect the control board 48 and the terminal block 46 to the equipment of the HVAC unit 12.

FIG. 3 illustrates a residential heating and cooling system 50, also in accordance with present techniques. The residential heating and cooling system 50 may provide heated and cooled air to a residential structure, as well as provide outside air for ventilation and provide improved indoor air quality (IAQ) through devices such as ultraviolet lights and air filters. In the illustrated embodiment, the residential heating and cooling system 50 is a split HVAC system. In general, a residence 52 conditioned by a split HVAC system may include refrigerant conduits 54 that operatively couple the indoor unit 56 to the outdoor unit 58. The indoor unit 56 may be positioned in a utility room, an attic, a basement, and so forth. The outdoor unit 58 is typically situated adjacent to a side of residence 52 and is covered by a shroud to protect the system components and to prevent leaves and other debris or contaminants from entering the unit. The refrigerant conduits 54 transfer refrigerant between the indoor unit 56 and the outdoor unit 58, typically transferring primarily liquid refrigerant in one direction and primarily vaporized refrigerant in an opposite direction.

When the system shown in FIG. 3 is operating as an air conditioner, a heat exchanger 60 in the outdoor unit 58 serves as a condenser for re-condensing vaporized refrigerant flowing from the indoor unit 56 to the outdoor unit 58 via one of the refrigerant conduits 54. In these applications, a heat exchanger 62 of the indoor unit 56 functions as an evaporator. Specifically, the heat exchanger 62 receives liquid refrigerant, which may be expanded by an expansion device, and evaporates the refrigerant before returning it to the outdoor unit 58.

The outdoor unit 58 draws environmental air through the heat exchanger 60 using a fan 64 and expels the air above the outdoor unit 58. When operating as an air conditioner, the air is heated by the heat exchanger 60 within the outdoor unit 58 and exits the unit at a temperature higher than it entered. The indoor unit 56 includes a blower or fan 66 that directs air through or across the indoor heat exchanger 62, where the air is cooled when the system is operating in air conditioning mode. Thereafter, the air is passed through ductwork 68 that directs the air to the residence 52. The overall system operates to maintain a desired temperature as set by a system controller. When the temperature sensed inside the residence 52 is higher than the set point on the thermostat, or a set point plus a small amount, the residential heating and cooling system may become operative to refrigerate additional air for circulation through the residence 52. When the temperature reaches the set point, or a set point minus a small amount, the residential heating and cooling system 50 may stop the refrigeration cycle temporarily.

The residential heating and cooling system 50 may also operate as a heat pump. When operating as a heat pump, the roles of heat exchangers 60 and 62 are reversed. That is, the heat exchanger 60 of the outdoor unit 58 will serve as an evaporator to evaporate refrigerant and thereby cool air entering the outdoor unit 58 as the air passes over outdoor the heat exchanger 60. The indoor heat exchanger 62 will receive a stream of air blown over it and will heat the air by condensing the refrigerant.

In some embodiments, the indoor unit 56 may include a furnace system 70. For example, the indoor unit 56 may include the furnace system 70 when the residential heating and cooling system 50 is not configured to operate as a heat pump. The furnace system 70 may include a burner assembly and heat exchanger, among other components, inside the indoor unit 56. Fuel is provided to the burner assembly of the furnace system 70 where it is mixed with air and combusted to form combustion products. The combustion products may pass through tubes or piping in a heat exchanger, separate from heat exchanger 62, such that air directed by the blower 66 passes over the tubes or pipes and extracts heat from the combustion products. The heated air may then be routed from the furnace system 70 to the ductwork 68 for heating the residence 52.

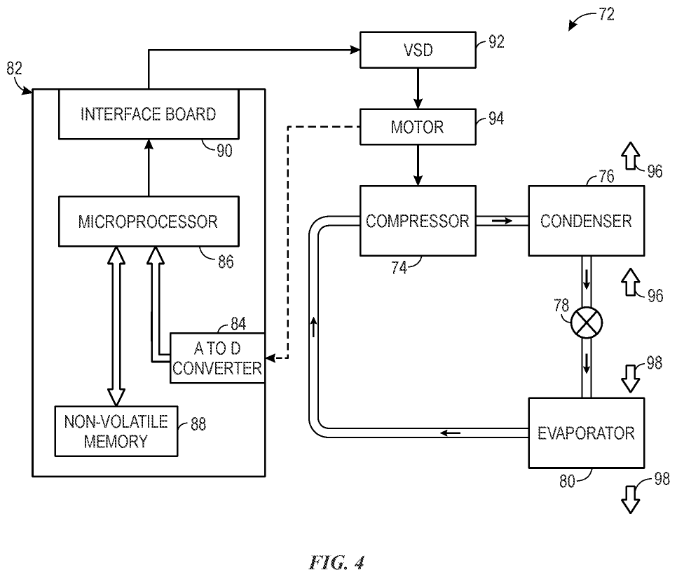

FIG. 4 is an embodiment of a vapor compression system 72 that can be used in any of the systems described above. The vapor compression system 72 may circulate a refrigerant through a circuit starting with a compressor 74. The circuit may also include a condenser 76, an expansion valve(s) or device(s) 78, and an evaporator 80. The vapor compression system 72 may further include a control panel 82 that has an analog to digital (A/D) converter 84, a microprocessor 86, a non-volatile memory 88, and/or an interface board 90. The control panel 82 and its components may function to regulate operation of the vapor compression system 72 based on feedback from an operator, from sensors of the vapor compression system 72 that detect operating conditions, and so forth.

In some embodiments, the vapor compression system 72 may use one or more of a variable speed drive (VSDs) 92, a motor 94, the compressor 74, the condenser 76, the expansion valve or device 78, and/or the evaporator 80. The motor 94 may drive the compressor 74 and may be powered by the variable speed drive (VSD) 92. The VSD 92 receives alternating current (AC) power having a particular fixed line voltage and fixed line frequency from an AC power source, and provides power having a variable voltage and frequency to the motor 94. In other embodiments, the motor 94 may be powered directly from an AC or direct current (DC) power source. The motor 94 may include any type of electric motor that can be powered by a VSD or directly from an AC or DC power source, such as a switched reluctance motor, an induction motor, an electronically commutated permanent magnet motor, or another suitable motor.

The compressor 74 compresses a refrigerant vapor and delivers the vapor to the condenser 76 through a discharge passage. In some embodiments, the compressor 74 may be a centrifugal compressor. The refrigerant vapor delivered by the compressor 74 to the condenser 76 may transfer heat to a fluid passing across the condenser 76, such as ambient or environmental air 96. The refrigerant vapor may condense to a refrigerant liquid in the condenser 76 as a result of thermal heat transfer with the environmental air 96. The liquid refrigerant from the condenser 76 may flow through the expansion device 78 to the evaporator 80.

The liquid refrigerant delivered to the evaporator 80 may absorb heat from another air stream, such as a supply air stream 98 provided to the building 10 or the residence 52. For example, the supply air stream 98 may include ambient or environmental air, return air from a building, or a combination of the two. The liquid refrigerant in the evaporator 80 may undergo a phase change from the liquid refrigerant to a refrigerant vapor. In this manner, the evaporator 80 may reduce the temperature of the supply air stream 98 via thermal heat transfer with the refrigerant. Thereafter, the vapor refrigerant exits the evaporator 80 and returns to the compressor 74 by a suction line to complete the cycle.

In some embodiments, the vapor compression system 72 may further include a reheat coil in addition to the evaporator 80. For example, the reheat coil may be positioned downstream of the evaporator relative to the supply air stream 98 and may reheat the supply air stream 98 when the supply air stream 98 is overcooled to remove humidity from the supply air stream 98 before the supply air stream 98 is directed to the building 10 or the residence 52.

It should be appreciated that any of the features described herein may be incorporated with the HVAC unit 12, the residential heating and cooling system 50, or other HVAC systems. Additionally, while the features disclosed herein are described in the context of embodiments that directly heat and cool a supply air stream provided to a building or other load, embodiments of the present disclosure may be applicable to other HVAC systems as well. For example, the features described herein may be applied to mechanical cooling systems, free cooling systems, chiller systems, or other heat pump or refrigeration applications.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

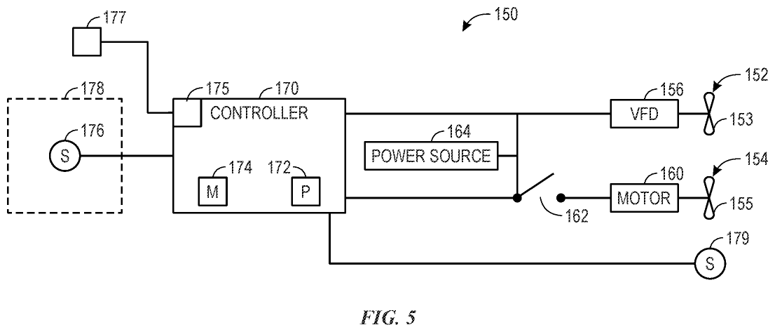

FIG. 5 is a schematic diagram of a heating, ventilation, and/or air conditioning (HVAC) system 150 for controlling a plurality of fan units. The HVAC system 150 may include a variable-speed fan 152 (e.g., a first fan, a variable-speed exhaust fan) and a constant-speed fan 154 (e.g., a second fan, a constant-speed exhaust fan). In certain embodiments, the variable-speed fan 152 and the constant-speed fan 154 may be the fans 32 of the heat exchanger 30. The variable-speed fan 152 and the constant-speed fan 154 may be fans of the same model controlled by different operators (e.g., motors, VFDs, controllers). The variable-speed fan 152 may operate at various speeds to deliver air at a variable airflow rate. The variable-speed fan 152 may rotate a first fan blade 153 at various speeds to deliver a first airflow at variable airflow rates. The constant-speed fan 154 may operate at a set (e.g., constant) speed. The constant-speed fan 154 may operate to rotate an associated fan blade (e.g., a second fan blade 155) at a fixed speed, which may include rotation within a range (e.g., within measurement error or operational error). At full output (e.g., after ramp up and before ramp down), the constant-speed fan may be operable to consistently rotate the second fan blade 155 at a certain rotational speed, such as 200 RPM with an error range of plus/minus 10 RPM for example. This rotational speed (e.g., including a limited range) may be referred to as the fixed speed. Thus, a constant-speed fan may operate to rotate the second fan blade 155 at a fixed speed when activated (e.g., after ramping up) and to stop (e.g., after ramping down) when deactivated. In some embodiments, the variable-speed fan 152 and the constant-speed fan 154 of the HVAC system 150 may be part of an exhaust system. For example, the HVAC system 150 may operate to deliver exhaust air from an HVAC unit to an exterior environment. The HVAC system 150 may operate (e.g., via the controller 170 discussed below) the variable-speed fan 152 and the constant-speed fan 154 to produce an airflow rate based on a target airflow rate. In some embodiments, each of the variable-speed fan 152 and the constant-speed fan 154 may have a maximum fan airflow rate equal to half of a maximum airflow rate for the HVAC system 150. For example, the HVAC system 150 may have a maximum airflow rate of 6000 cubic feet per minute (CFM). In this example, the variable-speed fan may have a maximum fan airflow rate of 3000 CFM and the constant-speed fan may have a maximum airflow rate of 3000 CFM. In other embodiments, the variable-speed fan 152 and the constant-speed fan 154 may have different maximum fan airflow rates that add up to the maximum airflow rate of the HVAC system 150. For example, the HVAC system 150 may have a maximum airflow rate of 6000 CFM, the variable-speed fan 152 may have a maximum fan airflow rate of 4000 CFM, and the constant-speed fan may have a maximum airflow rate of 2000 CFM. In other embodiments, the fan airflow rate of the variable-speed fan 152 and the constant-speed fan 154 may not add up to the maximum airflow rate of the HVAC system 150. For example, a sum of the maximum airflow rates of the variable-speed fan 152 and the constant-speed fan 154 may be greater or lesser than the maximum airflow rate of the HVAC system 150.

A variable frequency drive (VFD) 156 may drive the variable-speed fan 152 at various speeds. The VFD 156 (e.g., a first fan motor, a first drive) may be an AC motor, a DC motor, or any type of motor capable of driving a fan. The VFD 156 may be coupled to the variable-speed fan 152 via a shaft, or the like. The VFD 156 may regulate an electrical current to determine a frequency at which the VFD 156 drives the variable-speed fan 152. A fan motor 160 (e.g., a second fan motor, a second drive) may drive the constant-speed fan 154. Similar to the VFD 156, the fan motor 160 may be an AC motor, a DC motor, or any type of motor capable of driving a fan. The fan motor 160 may be coupled to the constant-speed fan 154 via a shaft, or the like. The fan motor 160 may be controlled via a switch 162. The switch 162 may toggle between an on position and an off position, and may electrically couple the fan motor 160 to an electrical power source 164. In the on position, the switch 162 allows an electrical current from the electrical power source 164 to power the fan motor 160. When the switch 162 is in the on position, the constant-speed fan 154 delivers air at a constant airflow rate that is dependent upon a value of the electrical current delivered by the electrical power source 164. In the off position, the switch 162 disconnects the electrical powers source 164 from the fan motor 160. The electrical power source 164 may be a battery, a generator, an electrical power grid, or another source of electricity. The electrical power source 164 may also supply power to the VFD 156. It should be noted that the FIG. 1 is a schematic diagram, and is not intended to accurately depict circuitry of the HVAC system 150. In certain embodiments, as described herein, the HVAC system may employ two variable-speed fans, a plurality of constant-speed fans, and one variable-speed fan, or another configuration of fans.

The VFD 158 and the switch 162 may be controlled by a controller 170. The controller 170 may include a processor 172 and a memory device 174. The processor 172 may include any suitable type of processing circuitry, such as one or more processors, one or more “general-purpose” microprocessors, one or more special-purpose microprocessors, and/or one or more application specific integrated circuits (ASICS), or some combination thereof. For example, the processor 172 may include one or more reduced instruction set (RISC) processors. The memory device 174 may include any suitable type of memory that stores instructions (e.g., software) executable by the processor 172, such as a non-volatile and/or volatile memory. The controller 170 may also include communication circuitry 175. The communication circuitry 175 may communicate (e.g., send and receive data, communicatively couple) with an external computing device 177 via a connection (e.g., a wireless fidelity (WiFi) network, a local area network (LAN)). In certain embodiments, the controller 170 may receive data via the communication circuitry 175 and store the data on the memory device 174. The data received by the memory device may be static pressure data, target airflow rate data, or stall region data for fans of the HVAC system 150.

The controller 170 may be coupled to a sensor 176 within an interior environment 178. The sensor 176 may be a temperature sensor (e.g., a thermocouple) configured to gather temperature data, a pressure sensor configured to gather pressure data, or another type of sensor. The interior environment 178 may be a conditioned space of a building (e.g., the building 10). In other embodiments, the interior environment 178 may be a location of the variable-speed fan 152 and the constant-speed fan 154. The controller 170 may utilize data received from the sensor 176 to determine, for example, a target airflow rate, a static pressure value, or another metric for operating the HVAC system 150. The controller 170 may also be coupled to a pressure sensor 179 located near the variable-speed fan 152 and the constant-speed fan 154. The pressure sensor 179 may gather data pertaining to a static pressure at the variable-speed fan 152 and the constant-speed fan 154. In certain embodiments, the pressure sensor 179 may be two pressure sensors and each pressure sensor of the two pressure sensors may be located at a respective fan of the two fans and configured to collect data pertaining to a static pressure at each fan. For example, a first pressure sensor 179 may be located hear and/or associated with the variable-speed fan 152 (e.g., collecting static pressure data of the variable-speed fan 152) and a second pressure sensor 179 may be located near and/or associated with the constant-speed fan 154 (e.g., collecting static pressure data of the constant-speed fan 154).

The controller 170 may control the VFD 156 and the switch 162 to operate the variable-speed fan 152 and the constant-speed fan 154 to deliver a target airflow rate. For example, the controller 170 may receive or determine a target airflow rate, identify respective airflow rates for each of the variable-speed fan 152 and the constant-speed fan 154 to provide to (in combination) achieve the target airflow rate, and operate the variable-speed fan 152 and the constant-speed fan 154 based on the identified airflow rates. The controller 170 may operate the VFD 156 to control the variable-speed fan 152, and operate the switch 162 to operate the constant-speed fan. The controller 170 may also control the variable-speed fan 152 and the constant-speed fan 154 to deliver the target airflow rate while avoiding stall regions for each fan. In accordance with present embodiments, the controller 170 may employ a lookup table or an algorithm to achieve this control.

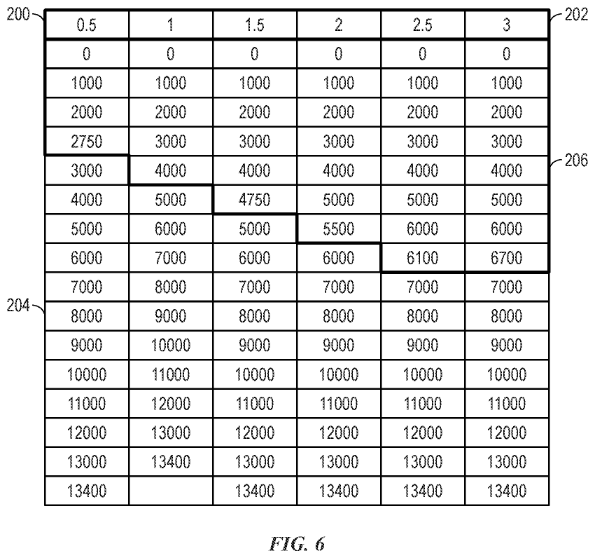

FIG. 6 is a table 200 of a plurality of stall regions for a fan unit of the plurality of fan units (e.g., the variable-speed fan 152, the constant-speed fan 154) of the HVAC system 150 at different static pressures and airflow rates. The depicted values of static pressures and airflow rates are examples and present embodiments address fans with differing characteristics that are associated with different values of static pressures and airflow rates. As described above, stall regions are modes of operation for fans at certain static pressures and airflow rates that result in suboptimal fan operation (e.g., noise, damage, inefficiency, reduced performance, performance issues). The present embodiments are directed to controlling the HVAC system 150 with the controller 170 (which may be representative of multiple controllers with multiple processors and memories) to deliver a target airflow rate while operating the variable-speed fan 152 and the constant-speed fan 154 outside of stall regions. The table 200 illustrates stall regions at certain static pressure values and airflow rates for a fan unit (e.g., the variable-speed fan 152, the constant-speed fan 154). The static pressure values represent static pressure local to the variable-speed fan 152 and/or the constant-speed fan 154. A top row 202 contains a number of static pressure values in inches of water gauge (in-wg). Values 204 in each column of the table 200 depict airflow rate values in cubic feet per minute (CFM) within an operating range for the fan at a corresponding static pressure. Stall region values 206 are depicted in grey cells. The stall region values 206 are airflow rates for each corresponding static pressure value at which the fan stalls. In certain embodiments, the stall region for the fan is on a lower end of a range of airflow rates corresponding to the fan. The fan may have a minimum operable airflow rate, and every airflow rate beneath the minimum operable airflow rate may be within the stall region. Additionally, the fan may have a maximum operable airflow rate, and every airflow rate above the maximum operable airflow rate may be within the stall region. The controller 170 may store a table like the table 200 on the memory device 174 to retrieve stall region values for the variable-speed fan 152 and the constant-speed fan 154. The controller 170 may employ this data in control schemes and algorithms in accordance with present embodiments.

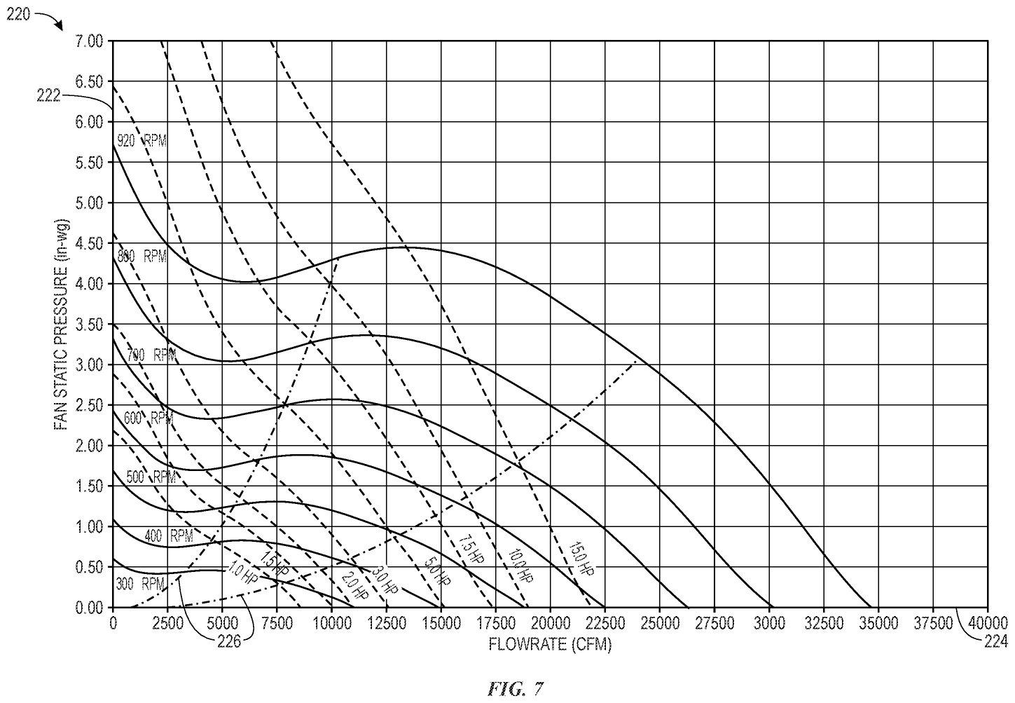

FIG. 7 is a chart 220 depicting a stall region for a fan unit of the plurality of fan units (e.g., the variable-speed fan 152, the constant-speed fan 154) of the HVAC system 150 at different static pressures and airflow rates. The chart 220 also depicts various rotations per minute (RPM) and horse-power (HP) values for the fan at each static pressure and airflow rate value. Similar to the table 200, the chart depicts an operating range for a fan (e.g., the variable-speed fan 152, the constant-speed fan 154). A vertical axis 222 represents static pressure values in in-wg. A horizontal axis 224 represents airflow rate values in CFM. Borders 226 represent edges of an operating range of the fan. For example, if the fan is operating at a static pressure and an airflow rate that falls between the borders 226, the fan may operate normally (without stalling). If the fan is operating at a static pressure and an airflow rate that falls to the left or right of the borders 226, the fan is in a stall region. The depicted values of static pressures, rotations per minute (RPMs), horsepower (HP), and airflow rates are examples and present embodiments address fans with differing characteristics that are associated with different values of the referenced metrics.

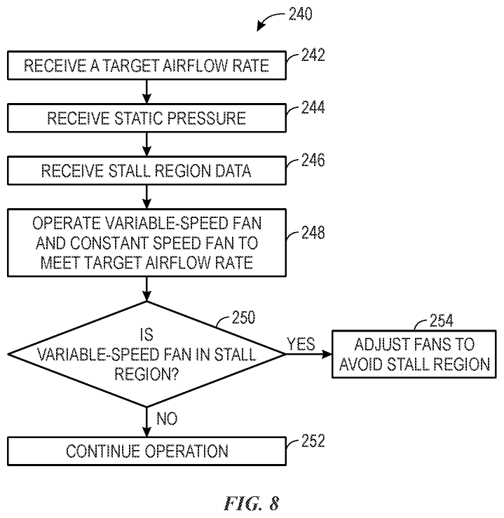

FIG. 8 is a flow chart illustrating a method 240 for operating the HVAC system 150 including the plurality of fan units (e.g., the variable-speed fan 152, the constant-speed fan 154) at different pressures and airflow rates. Specifically, the method 240 may represent an algorithm performed by an HVAC system controller (e.g., controller 170). Although the following description of the method 240 is described in a particular order, it should be noted that the method 240 is not limited to the depicted order; and, instead, the method 240 may be performed in any suitable order. As a specific example, the method 240 (or algorithm) will be described as being performed by the controller 170, in accordance with present embodiments.

At block 242, the controller 170 receives a target airflow rate (e.g., a target airflow rate value). In some embodiments, the controller 170 may receive the target airflow rate via the communication circuitry 175. The target airflow rate may be received from the computing device 177. The computing device 177 may be a thermostat, a personal device (e.g., a cell phone, a tablet, a laptop), or the like. The target airflow rate may be based on a target temperature value of the interior environment 178 input by a user. In other embodiments, the controller 170 determines (e.g., calculates) the target airflow rate based on data received from the sensor 176. For example, the sensor 176 may be a thermocouple that sends a temperature of the interior environment 178. The controller 170 may calculate a target airflow rate necessary to maintain the temperature of the interior environment 178 via the HVAC system 150. This calculation may be performed based on a lookup table or algorithm. Once the controller 170 receives the target airflow value, the controller 170 may store the target airflow rate in the memory device 174.

At block 244, the controller 170 receives a static pressure value. In some embodiments, the controller 170 may receive the static pressure value via the communication circuitry 175. The static pressure value may be received from the computing device 177. The computing device 177 may be coupled to a pressure sensor (e.g., the pressure sensor 179) located near the variable-speed fan 152 and/or the constant-speed fan 154. In some embodiments, the controller 170 receives the static pressure value from the sensor 176. For example, the sensor 176 may be a pressure sensor communicatively coupled to the controller 170. The sensor 176 may be disposed near the variable-speed fan 152 and/or the constant-speed fan 154 to detect a local static pressure value. Once the controller 170 receives the static pressure value, the controller 170 may store the static pressure value in the memory device 174.

At block 246, the controller 170 receives stall region data. The stall region data may be an array of airflow rates (e.g., airflow levels) corresponding to static pressure values at which the variable-speed fan 152 and the constant-speed fan 154 do not properly operate (or an equation or algorithm defining such relationships). The array (or equation/algorithm) may also define combinations of static pressure values and airflow rates for which the variable-speed fan 152 will properly operate. The array of airflow rates may be stored in a file format (e.g., .csv, .xls) that the processor 172 may read. The stall region data may also come in the form of a table (e.g., the table 200 of FIG. 6) or a chart (e.g., the chart 220 of FIG. 7). In some embodiments, the controller 170 may receive the stall region data from an external source (e.g., the computing device 177) via the communication circuitry 175. For example, the controller 170 may request the stall region data from the computing device 177 by sending a query to the computing device 177. The query may include an identifier (e.g., a model number, performance data) of the variable-speed fan 152, and the computing device 177 may retrieve the stall region data corresponding to the variable-speed fan 152 from a centralized source (e.g., a manufacturer's server) based on the identifier. Indeed, in accordance with present embodiments, an indexed database (e.g., stored locally on the controller 170 or on a remote memory) may allow for searching based on the identifier (e.g., model number or fan size) to obtain relevant algorithms or tables for determining stall region data. Once the stall region data is received, the controller 170 may store the stall region data on the memory device 174. In other embodiments, a user manually downloads the stall region data onto the memory device 174 upon installing the variable-speed fan 152.

At block 248, the controller 170 operates (e.g., activates) the variable-speed fan 152 and the constant-speed fan 154. This may be in response to a demand for cooling or the like by the HVAC system 150. An operational combination of the variable-speed fan 152 and the constant-speed fan 154 may include any of various combinations that are used for the purpose of achieving a combined output airflow. For example, the constant-speed fan 154 may be turned off and the variable-speed fan 152 may operate alone to achieve an airflow goal within the capability of the variable-speed fan 152 by itself. In another example, the constant-speed fan 154 may be turned on and combined with some of operational level (e.g., 10%, 50%, 100% output) of the variable-speed fan 152 to achieved a combined output airflow goal (e.g., target airflow rate). As a specific example, the variable-speed fan 152 may be capable of producing a first maximum airflow rate of X and the constant-speed fan 154 may be capable of producing a second airflow rate of Y. In this example, if the variable-speed fan 152 is operating fully (e.g., at 100%), the combined airflow rate for both would be X+Y and various airflow goals (e.g., target airflow rates) at and below this level can be achieved by different combinations of operation (or operational combinations) of the variable-speed fan 152 and the constant-speed fan 154. Based on the target airflow rate received at block 242, the controller 170 may operate one or both of the variable-speed fan 152 (e.g., at varying levels of operation) and the constant-speed fan 154 to deliver an airflow rate equal to the target airflow rate. For example, the controller 170 may receive a target airflow rate of 8,000 CFM via the communication circuitry 175. The variable-speed fan 152 and the constant-speed fan 154 may each have a maximum airflow rate of 13,400 CFM. The controller 170 may determine that the target airflow rate is lower than the maximum airflow rate of the variable-speed fan 152. In response, the controller 170 may operate the variable-speed fan 152 to deliver an airflow rate equal to the target airflow rate.

In another example, the controller 170 may receive a target airflow rate of 22,000 CFM via the communication circuitry 175. The controller 170 may determine that the target airflow rate is greater than the maximum airflow rate of the variable-speed fan 152, but lower than a combination of the maximum airflow rate of the variable-speed fan 152 and the maximum airflow rate of the constant-speed fan 154. In response, the controller 170 may operate the constant-speed fan 154 and the variable-speed fan 152 to deliver an airflow rate equal to the target airflow rate. The controller 170 may activate the constant-speed fan 154 to deliver an airflow at a constant airflow rate that is equal to the maximum airflow rate of the constant-speed fan 154. Additionally, the controller 170 may operate (e.g., modulate) an airflow of the variable-speed fan 152 to deliver an airflow rate equal to a difference between the target airflow rate and the maximum airflow rate of the constant-speed fan 154.

At block 250 (which may occur prior to actually activating the variable-speed fan 152 to operate at a particular speed), the controller 170 determines whether the variable-speed fan 152 is or will be operating within a stall region based on comparison to a set of pre-determined variables (e.g., data). The controller 170 may compare a current or target airflow rate value of the variable-speed fan 152 and the static pressure value to a list of stall region airflow rate values included (e.g., stored) in the stall region data received at block 246. If the current or target airflow rate value of the variable-speed fan 152 is equal to or within a threshold range of a stall region airflow rate value of the stall region data, the controller 170 may determine that the variable-speed fan 152 is operating within a stall region. As described above, operating the variable-speed fan 152 in a stall region may result in decreased performance. In this case (i.e., when the variable-speed fan 152 will be operating in or within a threshold of a stall region), the method 240 continues to block 254. If the current airflow rate value of the variable-speed fan 152 is not equal to or within a threshold range of a stall region airflow rate value of the stall region data, the controller 170 may determine that the variable-speed fan 152 is not operating within a stall region. In this case, the method 240 continues to block 252. It should be noted that comparisons performed by the method (or algorithm) 240 such as that described in blocks 246 may effectively occur without a comparison operation occurring after attempted implementation of control. Rather, metrics (e.g., flowrates and static pressures) that are defined to be within stall regions (or within a threshold with respect thereto) may be preemptively avoided based on designation as a stall region or within a threshold thereof.

At block 252, the controller 170 determines that the variable-speed fan 152 is operating outside of a stall region and continues operation. While operating outside of the stall region, the controller 170 may operate the variable-speed fan 152 until the controller 170 receives a new target airflow rate.

At block 254, the controller 170 determines that the variable-speed fan 152 is operating within a stall region and adjusts the variable-speed fan 152 and the constant-speed fan 154 to avoid operating the variable-speed fan 152 within the stall region. For example, the target airflow rate may be 22,000 CFM and the variable-speed fan 152 may be capable of delivering an airflow rate greater than 22,000 CFM. In a first state, the controller 170 may operate the variable-speed fan 152 to deliver 22,000 CFM at a static pressure value of 1 in-wg. The controller 170 may then determine that 22,000 CFM is within a stall region at 1 in-wg for the variable-speed fan 152. In response, the controller 170 may activate the constant-speed fan 154 to deliver 13,400 CFM and operate the variable-speed fan 152 to deliver 8,600 CFM (e.g., decrease the airflow rate of the variable-speed fan 152).

In another example, the controller 170 may operate the variable-speed fan 152 to deliver 3,000 CFM and operate the constant-speed fan 154 to deliver 13,400 CFM to meet a target airflow rate of 16,400 CFM at 1 in-wg. The controller 170 may then determine that 3,000 CFM is within a stall region at 1 in-wg for the variable-speed fan 152. In response, the controller 170 may deactivate the constant-speed fan 154, determine that 16,400 CFM is not within a stall region for the variable-speed fan 152, and operate the variable-speed fan 152 to deliver 16,400 CFM (e.g., increase the airflow rate of the variable-speed fan 152). In certain embodiments, the controller 170 may activate an additional constant-speed fan or operate an additional variable-speed fan to deliver an airflow equal to the target airflow rate. Indeed, any number of variable and constant speed fans may be employed and coordinated to achieve desired results in accordance with present embodiments. Further, while examples provided above reference attempting control with specific variables that fall within stall regions and then adjusting arrangements to accommodate, it should be noted that present embodiments include preemptively adjusting fan operations to avoid operation in the stall regions all together. For example, rather than attempt to use a variable-speed fan alone within a stall region and then switch to combined operation with a constant-speed fan, present embodiments may immediately switch to combined operation upon detecting a request (e.g., an airflow rate with a particular static pressure) that is known to be within a stall region for a particular variable-speed fan.

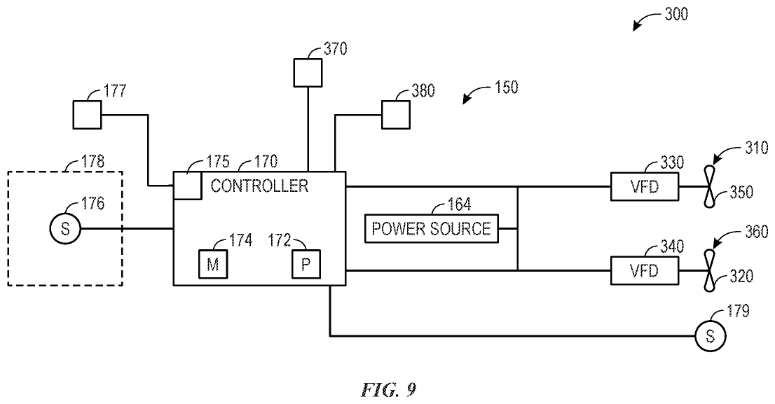

FIG. 9 is a schematic diagram of a heating, ventilation, and/or air conditioning (HVAC) system 300 for controlling a plurality of fan units, according to another aspect of the present disclosure. In FIG. 5 and FIG. 9, common parts have been given like reference numerals, and a description thereof has been omitted unless there is a particular need. It is understood that description of common parts as described in foregoing paragraphs associated with FIG. 5 applies to parts of FIG. 9 unless it is specifically described.

The HVAC system 300 may include two variable-speed fans, i.e., a first variable-speed fan 310 and a second variable-speed fan 320. A first variable frequency drive (VFD) 330 may drive the first variable-speed fan 310 at variable speeds and a second variable frequency drive (VFD) 340 may drive the second variable-speed fan 320 at variable speeds. The first variable-speed fan 310 may rotate a first fan blade 350 at various speeds to deliver a first airflow at variable airflow rates, whereas the second variable-speed fan 320 may rotate a second fan blade 360 at various speeds to deliver a second airflow at variable airflow rates. Moreover, each of the first and second VFD 330, 340 (e.g., a fan motor, a variable speed drive) may be an AC motor, a DC motor, or any type of motor capable of driving a fan. The first and second VFD 330, 340 may each be coupled respectively to the first and second variable-speed fans 310, 320 via a shaft, or the like. Each of the first and second VFD 330, 340 may regulate an electrical current to determine a frequency at which each of the first and second VFD 330, 340 drives the respective first and second variable-speed fans 310, 320. Further, each of the first and second VFD 330, 340 may be electrically coupled to an electrical power source 164. The electrical power source 164 may supply power to both the first and second VFD 330, 340. Respective capacities of the first variable-speed fan 310 and the second variable-speed fan 320 to deliver airflow may be same or different.

Furthermore, the HVAC system 300 may include a controller 170 to control operations of the first and second VFD 330, 340. In particular, the controller 170 may include a processor 172 and a memory device 174. The processor 172 may include any suitable type of processing circuitry, such as one or more processors, one or more “general-purpose” microprocessors, one or more special-purpose microprocessors, and/or one or more application specific integrated circuits (ASICS), or some combination thereof. For example, the processor 172 may include one or more reduced instruction set (RISC) processors. The memory device 174 may include any suitable type of memory that stores instructions (e.g., software) executable by the processor 172, such as a non-volatile and/or volatile memory. The controller 170 may also include communication circuitry 175. The communication circuitry 175 may communicate (e.g., send and receive data) with an external computing device 177 via a connection (e.g., a wireless fidelity (WiFi) network, a local area network (LAN)). In certain embodiments, the controller 170 may receive data via the communication circuitry 175 and store the data on the memory device 174. The data received by the memory device may be static pressure data, target airflow rate data, or stall region data for fans of the HVAC system 300.

The controller 170 may be coupled to a sensor 176 within an interior environment 178. The sensor 176 may be a temperature sensor (e.g., a thermocouple) configured to gather temperature data, a pressure sensor configured to gather pressure data, or another type of sensor. The interior environment 178 may be a conditioned space of a building (e.g., the building 10). In other embodiments, the interior environment 178 may be a location of the first variable-speed fan 310 and/or the second variable-speed fan 320. The controller 170 may utilize data received from the sensor 176 to determine, for example, a target airflow rate, a static pressure value, or another metric for operating the HVAC system 300. The controller 170 may also be coupled to a pressure sensor 179 located near the first variable-speed fan 310 and/or the second variable-speed fan 320. The pressure sensor 179 may gather data pertaining to a static pressure at the first variable-speed fan 310 and/or the second variable-speed fan 320. In certain embodiments, the pressure sensor 179 may be two pressure sensors and each pressure sensor of the two pressure sensors may be located at a respective fan of the two fans and configured to collect data pertaining to a static pressure at each fan. For example, a first pressure sensor 179 may be located hear and/or associated with the first variable-speed fan 310 (e.g., collecting static pressure data of the first variable-speed fan 310) and a second pressure sensor 179 may be located near and/or associated with the second variable-speed fan 320 (e.g., collecting static pressure data of the second variable-speed fan 320).

In addition, the controller 170 may control the first and/or second VFD 330, 340 to operate the first and/or second variable-speed fans 310, 320 to deliver a target airflow rate. For example, the controller 170 may receive or determine a target airflow rate, identify (e.g., determine) respective airflow rates for each of the first and/or second variable-speed fans 310, 320 to provide to (in combination) achieve the target airflow rate, and operate the first and/or second variable-speed fans 310, 320 based on the identified airflow rates. The controller 170 may also control the first and/or second variable-speed fans 310, 320 to deliver the target airflow rate while avoiding stall regions for each fan. In accordance with present embodiments, the controller 170 may employ a lookup table (e.g., table 200 of FIG. 6) or an algorithm to achieve this control.

In some embodiments, the controller 170 may utilize data received from the sensors 176, 179 to determine, for example, a target airflow rate, a static pressure value, or another metric for operating the HVAC system 300. In some embodiments, the controller 170 may receive the target airflow rate and static pressure data from the external computing device 177 as elaborated in foregoing paragraphs. Additionally or alternatively, in some embodiments, the controller 170 may receive a building static pressure data from a building data source 370, for example, a building management system. The controller 170 may receive the building static pressure data from a user having access to or knowledge of the building static pressure data. Once the controller 170 receives the building static pressure data, the controller 170 may store the building static pressure data in the memory 174.

In some embodiments, the controller 170 may be coupled to trigger equipment 380 (e.g., activating equipment, a switch, external controls) to receive trigger equipment status. In some embodiments, the controller 170 may determine to operate only a single fan (e.g., one fan) of the first variable-speed fan 310 and the second variable-speed fan 320 based on a status received via the trigger equipment 380, or to operate (e.g., simultaneously operate) both the first variable-speed fan 310 and the second variable-speed fan 320 based on the received status from the trigger equipment 380. For example, if the trigger equipment 380 is ON, the controller 170 may determine to actuate (e.g., activate, maintain activation of) a single fan (e.g., either the first variable-speed fan 310 or the second variable-speed fan 320) and maintain a non-operational status and/or deactivate the other fan. If the status of the trigger equipment 380 is OFF, the controller 170 may determine to operate (e.g., activate, actuate, maintain activation of) both the first and the second variable-speed fans 310, 320. Alternatively, in some embodiments, the controller 170 may determine to actuate only one fan of the first variable-speed fan 310 and the second variable-speed fan 320 and maintain a non-operational status and/or deactivate the other fan when the trigger equipment 380 status is OFF, and may determine to operate both the first and the second variable-speed fans 310, 320 when the trigger equipment 380 status is ON. Although the examples are described with trigger equipment 380 being ON or OFF, the controller 170 may utilize any other parameter of the trigger equipment 380 to determine to operate only one variable-speed fan of the first and second variable-speed fans 310, 320 or both of the first and second variable-speed fans 310, 320.

The trigger equipment 380 can be any suitable HVAC equipment in the HVAC system 300 associated with a status on which operation of the first and second variable-speed fans 310, 320 may be based. In some embodiments, the trigger equipment 380 may be an energy recovery wheel. In some embodiments, the trigger equipment 380 may be supply and/or exhaust fans. In some embodiments, the controller 170 may additionally utilize a target airflow rate in combination with the status of the trigger equipment to determine airflow rates (e.g., operation of) the first variable-speed fan 310 and/or the second variable-speed fan 320.

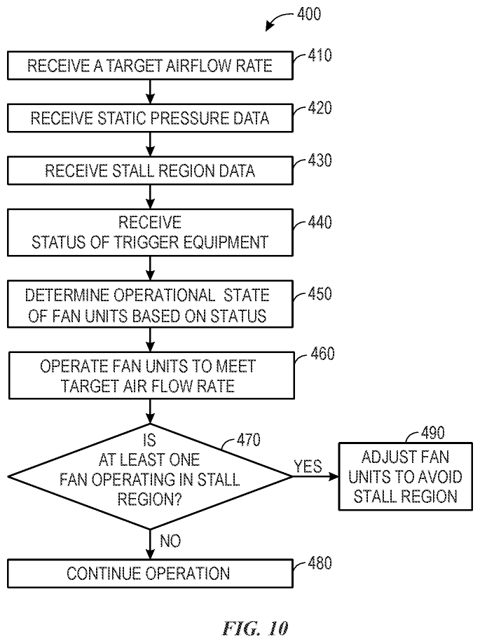

FIG. 10 is a flow chart illustrating a method 400 for operating the HVAC system 300 (e.g., the HVAC system 150) including the first and the second variable-speed fans 310, 320 at different pressures and airflow rates. Specifically, the method 400 may represent an algorithm performed by an HVAC system controller (e.g., controller 170). Although the following description of the method 400 is described in a particular order, it should be noted that the method 400 is not limited to the depicted order; and, instead, the method 400 may be performed in any suitable order. As a specific example, the method 400 (or algorithm) is described as being performed by the controller 170, in accordance with present aspect.

At block 410, the controller 170 receives or determines a target airflow rate. In some embodiments, the controller 170 may receive the target airflow rate via the communication circuitry 175. The target airflow rate may be received from the computing device 177. The computing device 177 may be a thermostat, a personal device (e.g., a cell phone, a tablet, a laptop), or the like. The target airflow rate may be based on a target temperature value of the interior environment 178 input by a user. In other embodiments, the controller 170 determines (e.g., calculates) the target airflow rate based on data received from the sensor 176. For example, the sensor 176 may be a thermocouple that sends a temperature of the interior environment 178. The controller 170 may calculate a target airflow rate necessary to maintain the temperature of the interior environment 178 via the HVAC system 150. This calculation may be performed based on a lookup table or algorithm. Once the controller 170 receives the target airflow value, the controller 170 may store the target airflow rate in the memory device 174.

At block 420, the controller 170 receives static pressure data. In some embodiments, the controller 170 may receive the static pressure value via the communication circuitry 175. The static pressure value may be received from the computing device 177. The computing device 177 may be coupled to a pressure sensor (e.g., the pressure sensor 179) located near the first variable-speed fan 310 and/or the second variable-speed fan 320. In some embodiments, the controller 170 receives the static pressure value from the sensor 179. For example, the sensor 179 may be a pressure sensor communicatively coupled to the controller 170. The sensor 179 may be disposed near the first variable-speed fan 310 and/or the second variable-speed fan 320 to detect a local static pressure value. Once the controller 170 receives the static pressure value, the controller 170 may store the static pressure value in the memory device 174.

At block 430, the controller 170 receives stall region data associated with the first variable-speed fan 310 and/or the second variable-speed fan 320. The stall region data may be an array of airflow rates (e.g., airflow levels) corresponding to static pressure values at which the first variable-speed fan 310 and/or the second variable-speed fan 320 do not properly operate (or an equation or algorithm defining such relationships). The array (or equation/algorithm) may also define combinations of static pressure values and airflow rates for which the first variable-speed fan 310 and/or the second variable-speed fan 320 will properly operate. The array of airflow rates may be stored in a file format (e.g., .csv, .xls) that the processor 172 may read. The stall region data may also come in the form of a table (e.g., the table 200 of FIG. 6) or a chart (e.g., the chart 220 of FIG. 7). In some embodiments, the controller 170 may receive the stall region data from an external source (e.g., the computing device 177) via the communication circuitry 175. For example, the controller 170 may request the stall region data from the computing device 177 by sending a query to the computing device 177. The query may include an identifier (e.g., a model number, performance data) of the first variable-speed fan 310 and/or the second variable-speed fan 320, and the computing device 177 may retrieve the stall region data corresponding to the first variable-speed fan 310 and/or the second variable-speed fan 320 from a centralized source (e.g., a manufacturer's server) based on the identifier. Indeed, in accordance with present embodiments, an indexed database (e.g., stored locally on the controller 170 or on a remote memory) may allow for searching based on the identifier (e.g., model number or fan size) to obtain relevant algorithms or tables for determining stall region data. Once the stall region data is received, the controller 170 may store the stall region data on the memory device 174. In other embodiments, a user manually downloads the stall region data onto the memory device 174 upon installing the variable-speed fan 152.

At block 440, the controller 170 receives a status associated with the trigger equipment 380. The controller 170 may be communicatively coupled to the trigger equipment 380. In addition, the status may be associated with an operational state (e.g., status, condition) of each fan unit (e.g., the first and/or the second variable-speed fan 310, 320) of the plurality of fan units of the HVAC system 300. In some embodiments, the controller 170 may query the trigger equipment 380 and determine and/or receive one or more parameters of the trigger equipment 380 associated with determining a number of fans to be operated based on received results from the query. In some other embodiments, the controller 170 may be communicatively coupled to one or more sensors associated with the trigger equipment 380 and receive the status (e.g., an indication of the status) of the trigger equipment 380 via data received from the one or more sensors. In some embodiments, the status of the trigger equipment 380 may include information (e.g., data) related to one or more parameters of the trigger equipment 380. Thus, the status may indicate and/or enable the controller 170 to determine a number of fans to be operated. For example, the status may include an indication of an operating condition of the trigger equipment 380 such as an ON or an OFF condition. In some embodiments, the status may include sensed data related to one or more parameters associated with the trigger equipment 380 such as power consumption, current output (e.g., capacity), current input, etc.

At block 450, the controller 170 may determine an operational state (e.g., modulate, activated, actuate, maintain activation of, deactivated, abstain from activating) of a each fan unit of the plurality of fan units of the HVAC system 300. For example, the controller 170 may be equipped with logic and lookup or data tables based on a status of the trigger equipment 380. The data tables may be provided for each parameter of the one or more parameters associated with the trigger equipment 380. A respective data table and logic may be provided for each trigger equipment 380 of a plurality of trigger equipment 380 associated with the HVAC system 300. For example, the trigger equipment 380 may be an energy recovery wheel. As such, the controller 170 may determine to actuate (e.g., activate, maintain activation of) only one fan of the first and second variable-speed fans 310, 320 when the status of the energy recovery wheel is ON, and may determine to operate (e.g., modulate, activate, maintain activation of) both fans of the first and second variable-speed fans 310, 320 when the status of the energy recovery wheel is OFF. Similar logic may be embedded in the controller 170 related to other trigger equipment. For example, a supply fan and/or an exhaust fan of the HVAC system 300 may be the trigger equipment 380 and the controller 170 may determine to operate a single fan or both fans of the first and second variable-speed fans 310, 320 based on an operating condition (e.g., status, ON/OFF status) of a supply fan and/or an exhaust fan. In some embodiments, the controller 170 may determine to operate (e.g., modulate, activate, maintain activation of) a single fan or both fans of the first and second variable-speed fans 310, 320 based on other parameters of the trigger equipment 380.

At block 460, the controller 170 operates (e.g., activate, modulate) the first variable-speed fan 310 and/or the second variable-speed fan 320 to meet the target airflow rate. In some embodiments, when the controller 170 has determined to operate a single fan of the first and second variable-speed fans 310, 320, the controller 170 may operate the single fan such that the output airflow rate associated with the single fan is approximately equal to the target airflow rate. This may be in response to a demand for cooling, based on a status of the trigger equipment 380, or the like of the HVAC system 300. In some embodiments, when the controller 170 has determined to operate both fans of the first and second variable-speed fans 310, 320, the controller 170 may determine an operational combination of the first variable-speed fan 310 and the second variable-speed fan 320 to achieve a combined output airflow rate approximately equal to the target airflow rate. For example, the first variable-speed fan 310 may be activated at some operational level (e.g., 10%, 50%, 100% output) in combination with the second variable-speed fan 320 activated at some operational level (e.g., 10%, 50%, 100% output) to achieved a combined output airflow goal (e.g., target airflow rate). As a specific example, the first variable-speed fan 310 may be capable of producing a first maximum airflow rate of X and the second variable-speed fan 320 may be capable of producing a second maximum airflow rate of Y. In this example, if the first variable-speed fan 310 is operating fully (e.g., at 100%) and the second variable-speed fan 320 is operating fully (e.g., at 100%), the combined maximum airflow rate for both would be X+Y. Various airflow goals (e.g., target airflow rates) at and below the maximum level of operation can be achieved by different combinations of respective operational levels (e.g., operational combinations) of the first variable-speed fan 310 and the second variable-speed fan 320. Based on the target airflow rate received at block 242, the controller 170 may operate the first variable-speed fan 310 and the second variable-speed fan 320, each at a determined respective operational level, to deliver an airflow rate equal to the target airflow rate. For example, the controller 170 may receive a target airflow rate of 22,000 CFM via the communication circuitry 175. The first variable-speed fan 310 and the second variable-speed fan 320 may each have a maximum airflow rate of 13,400 CFM. The controller 170 may determine that the target airflow rate is greater than the maximum airflow rate of the first variable-speed fan 310, but lower than a combination of the maximum airflow rate of the first variable-speed fan 310 and the maximum airflow rate of the second variable-speed fan 320. In response, the controller 170 may operate both the first variable-speed fan 310 and the second variable-speed fan 320 each at respective determined operational levels to deliver an airflow rate equal to the target airflow rate. The controller 170 may operate (e.g., modulate) the first variable-speed fan 310 to deliver an airflow at an airflow rate that is equal to 75% of the maximum airflow rate of the first variable-speed fan 310. Additionally, the controller 170 may operate (e.g., modulate) an airflow of the second variable-speed fan 320 to deliver an airflow rate equal to a difference between the target airflow rate and 75% of the maximum airflow rate of the first variable-speed fan 310 (e.g., approximately 89% of the maximum airflow rate of the second variable-speed fan 320.

In some embodiments, the controller 170 may determine respective airflow rates associated with each of the first and the second variable-speed fans 310, 320 to operate the first and second variable-speed fans 310, 320 such that a respective stall region associated with each of the first and the second variable-speed fans 310, 320 is avoided. For example, if a target airflow rate is 16,000 CFM and the controller 170 determines (e.g., via the sensor 179) respective airflow rates to be 6,000 CFM for the first variable-speed fan 310 and 10,000 CFM for the second variable-speed fan 320, the first variable-speed fan 310 will operate in the stall region. In response, the controller 170 may operate (e.g., adjust operation of) the first variable-speed fan to produce an airflow rate of 7,000 CFM and operate (e.g., adjust operation of) the second variable-speed fan 320 to produce an airflow rate of 9,000 CFM to avoid (e.g., prevent operation of) the first variable-speed fan 310 in the stall region.

At block 470 (which may occur prior to actually activating the variable-speed fan 152 to operate at a particular speed), the controller 170 determines whether the first and/or the second variable-speed fans 310, 320 are or will be operating within a respective stall region associated with the first and/or the second variable-speed fans 310, 320 based on comparison to a set of pre-determined variables (e.g., data). In some embodiments, when the controller 170 decides to operate single fan, for example the first variable-speed fan 310 based on the status of the trigger equipment 380 (e.g., block 450), the controller 170 may determine whether the first variable-speed fan 310 is or will be operating in a stall region. In some embodiments, when the controller 170 determines to operate both the first and the second variable-speed fans 310, 320 (e.g., based on the status of the trigger equipment 380), the controller 170 may determine whether at least one fan of the first and second variable-speed fans 310, 320 is or will be operating in a stall region. The controller 170 may compare a respective current or target airflow rate value associated with each of the first and/or the second variable-speed fans 310, 320 and the static pressure value to a list of stall region airflow rate values (e.g., associated with each of the first and second variable-speed fans 310, 320) included (e.g., stored) in the stall region data received at block 430. For each of the first and/or second variable-speed fans 310, 320, if the current or target airflow rate value of the first and/or second variable-speed fans 310, 320 is equal to or within a threshold range of a stall region airflow rate value of the stall region data, the controller 170 may determine that the first and/or second variable-speed fans 310, 320 is (e.g., or will be) operating within a stall region. As described above, the first and/or second variable-speed fans 310, 320 in a stall region may result in decreased performance. In this case (i.e., when the variable-speed fan 15 the first and/or second variable-speed fans 310, 320 will be operating in or within a threshold of a stall region), the method 400 continues to block 490. If the respective current airflow rate value of the first and/or second variable-speed fans 310, 320 is not equal to or within a threshold range of a stall region airflow rate value of the stall region data, the controller 170 may determine that the variable-speed fan 152 the first and/or second variable-speed fans 310, 320 is not (e.g., or will not be) operating within a stall region. In this case, the method 400 continues to block 480.

It should be noted that comparisons performed by the method (or algorithm) 400 such as that described in blocks 470 may effectively occur without a comparison operation occurring after attempted implementation of control. Rather, metrics (e.g., flowrates and static pressures) that are defined to be within stall regions (or within a threshold with respect thereto) may be preemptively avoided based on designation as a stall region or within a threshold thereof.

At block 480, the controller 170 determines that the first and/or second variable-speed fans 310, 320 are each operating outside of a stall region and continues operation of the first and/or second variable-speed fans 310, 320. While operating outside of the stall region, the controller 170 may operate first and/or second variable-speed fans 310, 320 until the controller 170 receives a new target airflow rate.

At block 490, the controller 170 determines that at least one of the first and/or second variable-speed fans 310, 320 is or will be operating within a stall region and adjusts the first and/or second variable-speed fans 310, 320 to avoid operating the first and/or second variable-speed fans 310, 320 within the stall region. For example, the target airflow rate may be 22,000 CFM and the first variable-speed fan 310 may be capable of delivering an airflow rate greater than 22,000 CFM. In a first state, the controller 170 may operate the first variable-speed fan 310 to deliver 22,000 CFM at a static pressure value of 1 in-wg. The controller 170 may then determine that 22,000 CFM is within a stall region at 1 in-wg for the first variable-speed fan 310. In response, the controller 170 may activate the second variable-speed fan 320 to deliver 13,400 CFM and operate the first variable-speed fan 310 to deliver 8,600 CFM (e.g., decrease the airflow rate of the first variable-speed fan 310).

In another example, the controller 170 may operate the first variable-speed fan 310 to deliver 3,000 CFM and operate the second variable-speed fan 320 to deliver 13,400 CFM to meet a target airflow rate of 16,400 CFM at 1 in-wg. The controller 170 may then determine that 3,000 CFM is within a stall region at 1 in-wg for the first variable-speed fan 310. In response, the controller 170 may deactivate the second variable-speed fan 320, determine that 16,400 CFM is not within a stall region for the first variable-speed fan 310, and operate the first variable-speed fan 310 to deliver 16,400 CFM (e.g., increase the airflow rate of the first variable-speed fan 310). In certain embodiments, the controller 170 may activate an additional constant-speed fan or operate an additional variable-speed fan to deliver an airflow equal to the target airflow rate. Indeed, any number of variable and constant speed fans may be employed and coordinated to achieve desired results in accordance with present embodiments. Further, while examples provided above reference attempting control with specific variables that fall within stall regions and then adjusting arrangements to accommodate, it should be noted that present embodiments include preemptively adjusting fan operations to avoid operation in the stall regions all together. For example, rather than attempt to use a variable-speed fan alone within a stall region and then switch to combined operation with a second variable-speed fan, present embodiments may immediately switch to combined operation upon detecting a request (e.g., an airflow rate with a particular static pressure) that is known to be within a stall region for a particular variable-speed fan.

Additionally or alternatively, in some embodiments, when the controller 170 determines and/or receives an indication that one or more fan units (e.g., the first and/or the second variable speed fans 310, 320) are or will be operating in stall region, the controller 170 may transmit an indication (e.g., an alert) that one or more of the fan units are operating or will be operating in a stall region. In particular, the indication may be displayed on a user interface. In some embodiments, the indication may be a noise in the ductwork 14. For example, if the controller 170 continues to operate the first and/or second variable-speed fans 310, 320 (e.g., override adjusting operation to avoid a stall region) in stall region, airflow through the ductwork 14 associated with the first and/or second variable-speed fans 310, 320 may create noise. Noise may be an indication of the first and/or second variable-speed fans 310, 320 operating in a stall region. In some embodiments, the controller 170 may provide a notification on a user interface indicating that the first and/or second variable-speed fans 310, 320 are or will be operating in a stall region. The notification may be in the form of audio and/or a video notification. Based on the notification, an operator of the HVAC system 100, 300 or a system (such as BMS) associated with a building can take appropriate measures to avoid operation of the first and/or second variable-speed fans 310, 320 in a stall region.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A heating, ventilation, and/or air conditioning (HVAC) system, comprising:
a variable-speed fan comprising a first fan blade;
a variable frequency drive (VFD) configured to drive the variable-speed fan to rotate the first fan blade at various speeds to deliver a first airflow at variable airflow rates;
a constant-speed fan having a second fan blade;
a fan motor of the constant-speed fan configured to rotate the second fan blade at a fixed speed to deliver a second airflow; and
a controller comprising memory and one or more processors, wherein the one or more processors is configured operate based on instructions in the memory such that the controller is configured to determine an operational combination of the variable-speed fan and the constant-speed fan that achieves a target flow rate with a combination of the first airflow and the second airflow without operating the variable-speed fan in a stall region based on stall region data for the variable-speed fan.

2. The HVAC system of claim 1, wherein the controller is configured to receive the stall region data from a computing device external to the HVAC system.

3. The HVAC system of claim 1, wherein the controller is configured to:
receive temperature data from a sensor, wherein the temperature data comprises a temperature of a conditioned space; and
determine the target flow rate based on the temperature data.

4. The HVAC system of claim 1, wherein the controller is configured to deactivate the constant-speed fan and instruct the VFD to increase a speed of rotation of the first fan blade based on the target flow rate and the stall region data.

5. The HVAC system of claim 1, wherein the controller is configured to activate the constant-speed fan and instruct the VFD to reduce a speed of rotation of the first fan blade based on the target flow rate and the stall region data.

6. The HVAC system of claim 5, wherein the target flow rate is an increase from a previous target flow rate and wherein the target flow rate is beyond a capacity of the variable-speed fan alone.

7. The HVAC system of claim 1, wherein the controller is configured to receive the target flow rate from a computing device external to the HVAC system.

8. The HVAC system of claim 7, wherein the computing device is a thermostat, and wherein the computing device generates the target flow rate based on a user input.

9. The HVAC system of claim 1, comprising an additional constant-speed fan.

10. The HVAC system of claim 9, wherein the controller is configured to operate the constant-speed fan, the additional constant-speed fan, and the variable-speed fan to deliver combined flow corresponding to the target flow rate.

11. An exhaust system for a heating, ventilation, and/or air conditioning (HVAC) system, comprising:
a variable-speed exhaust fan configured to deliver a first airflow from a conditioned space at a variable airflow rate;
a variable frequency drive (VFD) configured to drive the variable-speed exhaust fan at various speeds;
a constant-speed exhaust fan configured to deliver a second airflow from the conditioned space;
a fan motor configured to drive the constant-speed exhaust fan at a constant speed; and
a controller configured to:
receive a target airflow rate;
receive stall region data comprising an array of operational parameters of the variable-speed exhaust fan that result in decreased performance; and
determine, based on the target airflow rate and the stall region data, an operational combination of the variable-speed exhaust fan and the constant-speed exhaust fan that achieves the target airflow rate with a combination of the first airflow and the second airflow without operating the variable-speed exhaust fan in a stall region.

12. The exhaust system of claim 11, wherein the stall region data defines airflow levels and corresponding static pressures that cause the variable-speed exhaust fan to have decreased performance issues including increased noise, decreased efficiency, or both.

13. The exhaust system of claim 11, wherein the array of operational parameters comprises airflow rates corresponding to various static pressure values.

14. The exhaust system of claim 11, wherein the controller is configured to:
receive temperature data from a sensor, wherein the temperature data comprises a temperature of the conditioned space; and
determine the target airflow rate based on the temperature data.

15. The exhaust system of claim 11, wherein the controller is configured to receive the target airflow rate from a computing device external to the HVAC system, wherein the computing device is a thermostat, and wherein the computing device generates the target airflow rate based on a user input.

16. The exhaust system of claim 11, comprising an additional constant-speed exhaust fan, wherein the controller is configured to operate the constant-speed exhaust fan, the additional constant-speed exhaust fan, and the variable-speed exhaust fan to deliver combined airflow corresponding to the target airflow rate.

17. A method, comprising:
receiving, via a controller, a target airflow rate for an exhaust system, wherein the target airflow rate comprises an airflow rate value to be delivered by the exhaust system, which includes at least one variable-speed fan and at least one constant-speed fan;
receiving, via the controller, stall region data comprising an array of airflow rates within stall regions of the at least one variable-speed fan that result in decreased performance for the at least one variable-speed fan;
determining, via the controller and based on the stall region data, that the at least one variable-speed fan is set for operating at an airflow rate that is in one of the stall regions; and
in response to determining that the at least one variable-speed fan is set for operating in the one of the stall regions, activating, via the controller, the at least one constant-speed fan and operating the at least one variable-speed fan at an airflow rate outside of the stall regions such that combined airflow from the at least one variable-speed fan and the at least one constant-speed fan correspond to the target airflow rate.

18. The method of claim 17, wherein the target airflow rate is greater than an immediately preceding target airflow rate.

19. The method of claim 18, comprising operating the at least one variable-speed fan at a reduced speed.

20. The method of claim 19, wherein activating the at least one constant-speed fan comprises actuating a switch to connect a power source to a fan motor configured to drive the at least one constant-speed fan.
